(19) United States
(12) Patent Application Publication
(10) Pub. No.: US 2022/0220246 A1
(43) Pub. Date: Jul. 14, 2022

(54) COMPOSITE MATERIAL COMPRISING GRAPHENE QUANTUM DOTS AND METHOD FOR PREPARING THE SAME

(71) Applicant: Wuxi JHT Homewares Co., Ltd., Wuxi (CN)

(72) Inventor: Yong WAN, Wuxi (CN)

(21) Appl. No.: 17/198,206

(22) Filed: Mar. 10, 2021

(30) Foreign Application Priority Data
Jan. 11, 2021 (CN) 202110029490.8

(51) Int. Cl. C08G 18/32; C08K 5/00; C08K 5/06; A47G 9/10; C08K 3/04

(52) U.S. Cl. CPC C08G 18/3203; C08K 5/0025; C08K 5/0058; B82Y 40/00; A47G 9/10; C08K 3/042; C08K 5/06

(57) ABSTRACT

A composite material includes, by weight, 50-70 parts of polyol; 15-35 parts of polyether polyol; 0.5-1.5 parts of a polyester pigment or water-based resin-free pigment having a particle size of 100-500 meshes; 2.7-3.4 parts of silicone oil; 0.1-0.3 parts of a crosslinking agent; 0.1-0.3 parts of a catalyst; 2-6 parts of water; and 0.2-0.7 parts of graphene quantum dots (GQDs).

### CROSS-REFERENCE TO RELAYED APPLICATIONS

Pursuant to 35 U.S.C. § 119 and the Paris Convention Treaty, this application claims foreign priority to Chinese Patent Application No. 202110029490.8 filed on Jan. 11, 2021, the contents of which, including any intervening amendments thereto, are incorporated herein by reference. Inquiries from the public to applicants or assignees concerning this document or the related applications should be directed to: Matthias Scholl P C., Attn.: Dr. Matthias Scholl Esq., 245 First Street, 18th Floor, Cambridge, Mass. 02142.

### BACKGROUND

The disclosure relates to the field of composite material, and more particularly, to a composite material comprising graphene quantum dots and method for preparing the same.

The polyurethane foam pillows have poor air and water permeability and they easily grow mildew.

Conventionally, polyurethane foam pillows include synthetic organic antiseptic materials or auxiliaries. They have poor heat resistance and thermal stability, and may produce harmful volatiles after a period of use.

To improve the antibacterial effect of the pillows, graphene materials are added to polyurethane materials. This adversely affects the properties of polyurethane materials, that is, reducing the mechanical properties of polyurethane materials.

### SUMMARY

One objective of the disclosure is to provide a polyurethane pillow that is antibacterial and easily shaped.

To achieve above objective, in one aspect, the disclosure provides a composite material comprising, by weight, 50-70 parts of polyol; 15-35 parts of polyether polyol; 0.5-1.5 parts of a polyester pigment or water-based resin-free pigment having a particle size of 100-500 meshes; 2.7-3.4 parts of silicone oil; 0.1-0.3 parts of a crosslinking agent; 0.1-0.3 parts of a catalyst; 2-6 parts of water; and 0.2-0.7 parts of graphene quantum dots (GQDs).

In a class of this embodiment, the polyether polyol comprises 20-30 parts of a first polyether polyol and 5-25 parts of a second polyether polyol.

In a class of this embodiment, the first polyether polyol is propylene oxide polyether polyol terminated with ethylene oxide accounting for 15 wt. % of the composite material, and has a molecular weight of 1000-2000, a functionality of 3, and a hydroxyl value of 50-170.

In a class of this embodiment, the second polyether polyol is ethylene oxide polyol terminated with propylene oxide accounting for 15 wt. % of the composite material, and has a functionality of 2 and a hydroxyl value of 100.

In a class of this embodiment, the propylene oxide polyether polyol terminated with ethylene oxide accounting for 15 wt. % of the composite material is prepared as follows: with low molecular weight polyether diol as an initiator, in the presence of the catalyst, mixing propylene oxide and polyether diol, and then adding ethylene oxide, as an end-capping agent and accounting for 15 wt. % of the composite material, to the mixture of propylene oxide and polyether diol; neutralizing, filtering, and concentrating the mixture under vacuum.

In a class of this embodiment, the ethylene oxide polyol terminated with propylene oxide accounting for 15 wt. % of the composite material is prepared as follows: with low molecular weight polyether diol as an initiator, in the presence of the catalyst, mixing ethylene oxide and polyether diol, and then adding propylene oxide, as an end-capping agent and accounting for 15 wt. % of the composite material, to the mixture of ethylene oxide and polyether diol; and neutralizing, filtering, and concentrating the mixture under vacuum.

In a class of this embodiment, the graphene quantum dots comprise a carbon nano material with a size of a graphene sheet less than 100 nm and a number of graphene sheets less than 10.

In a class of this embodiment, the silicone oil comprises dimethyl silicone oil and polyether silicone oil with a mass ratio of 1:4 thereof.

The disclosure also provides a method of preparing the composite material, the method comprising:
adding 50-70 parts by weight of polyol, 20-30 parts by weight of a first polyether polyol, and 5-25 parts by weight of a second polyether polyol to a reactor, and stirring at a temperature of 50-70° C.;
adding 2.7-3.4 parts of silicone oil, 0.1-0.3 parts of the crosslinking agent, 0.1-0.3 parts of the catalyst, and 2-6 parts of water to the reactor, and centrifuging a resulting mixture at a speed of 300-500 rpm; and

adding 0.2-0.7 parts of graphene quantum dots and 0.5-1.5 parts of the polyester pigment or water-based resin-free pigment to the reactor, and allowing a mixture in the reactor to react at 10-30° C.

In another aspect, the disclosure provides a method of preparing a pillow, the method comprising molding the composite material in the shape of a pillow.

The following advantages are associated with the composite material of the disclosure:

1. The polyurethane foam prepared by the composite material are comfortable and the microbiological analysis thereof from Greenchem Laboratory Services based on AATCC-100 standard shows the antibacterial effect of the polyurethane foam against Staphylococcus aureus, Klebsiella pneumoniae and Escherichia coli is above 99.0%.

2. The polyurethane foam pillows prepared by the composite material are breathable and have good heat dissipation properties.

3. The hand feeling of the polyurethane foam pillows prepared by the composite material are not affected by the addition of graphene quantum dots, and the pillows can maintain soft and resilient for a long time.

4. The method is easy to operate, inexpensive, and can be used for mass production. The produced pillow is plastic and can exhibit different shapes. The graphene quantum dots have an antibacterial effect, thus preventing the pillows from becoming mildewy.

### DETAILED DESCRIPTION

To further illustrate, embodiments detailing a composite material comprising graphene quantum dots are described below. It should be noted that the following embodiments are intended to describe and not to limit the disclosure.

### EXAMPLE 1

A composite material comprises, by weight:

60 parts of polyol;

25 parts of a first polyether polyol;

15 parts of a second polyether polyol;

one part of a polyester pigment or water-based resin-free pigment having a particle size of 100-500 meshes;

3 parts of silicone oil;

0.2 parts of a crosslinking agent;

0.2 parts of a catalyst;

4 parts of water; and

0.5 parts of graphene quantum dots (GQDs).

The first and second first polyether polyols are primary reaction materials. The crosslinking agent is configured to improve the mechanical properties of foam, so that the product prepared by the composite material is resilient.

The first polyether polyol is propylene oxide polyether polyol terminated with ethylene oxide accounting for 15 wt. % of the composite material, and has a molecular weight of 1000-2000, a functionality of 3, and a hydroxyl value of 50-170. The second polyether polyol is ethylene oxide polyol terminated with propylene oxide accounting for 15 wt. % of the composite material, and has a functionality of 2 and a hydroxyl value of 100.

Specifically, the propylene oxide polyether polyol terminated with ethylene oxide accounting for 15 wt. % of the composite material is prepared as follows: with low molecular weight polyether diol as an initiator, in the presence of the catalyst, mixing propylene oxide and polyether diol, and then adding ethylene oxide, as an end-capping agent and accounting for 15 wt. % of the composite material, to the mixture of propylene oxide and polyether diol; and neutralizing, filtering, and concentrating the mixture under vacuum.

Specifically, the ethylene oxide polyol terminated with propylene oxide accounting for 15 wt. % of the composite material is prepared as follows: with low molecular weight polyether diol as an initiator, in the presence of the catalyst, mixing ethylene oxide and polyether diol, and then adding propylene oxide, as an end-capping agent and accounting for 15 wt. % of the composite material, to the mixture of ethylene oxide and polyether diol; and neutralizing, filtering, and concentrating the mixture under vacuum.

Compared with the traditional ethylene oxide terminated propylene oxide polyether polyol, the propylene oxide polyether polyol terminated with 15% ethylene oxide of the disclosure enables the polyether polyol has the properties of high activity, good temperature sensitivity at low temperature, good thermoplastic property and good tear strength.

In certain embodiments, the graphene quantum dots comprise a carbon nano material with a size of a graphene sheet less than 100 nm and a number of graphene sheets less than 10.

In certain embodiments, the silicone oil comprises dimethyl silicone oil and polyether silicone oil with a mass ratio of 1:4 thereof.

The following advantages are associated with the composite material of the disclosure. The composite material comprises polyol and the first and second first polyether polyols as primary raw material. The synergistic effect of the components makes the composite material have good stability, and the graphene quantum dots improves the bactericidal effect of the composite material, thus preventing the pillows from becoming mildewy.

### EXAMPLE 2

A method of preparing the composite material in Example 1 comprises:

1) adding 60 parts by weight of polyol, 25 parts by weight of the first polyether polyol, and 15 parts by weight of the second polyether polyol to a reactor, and stirring at a temperature of 50-70° C.;

2) adding 3 parts of silicone oil, 0.2 parts of the crosslinking agent, 0.2 parts of the catalyst, and 4 parts of water to the reactor, and centrifuging a resulting mixture at a speed of 300-500 rpm; and

3) adding 0.5 parts of graphene quantum dots and 1 part of the polyester pigment or water-based resin-free pigment to the reactor, and allowing a mixture in the reactor to react at 10-30° C.

The method is easy to operate, inexpensive, and can be used for mass production.

### EXAMPLE 3

A method of preparing a pillow comprises molding the composite material in Example 1 into a pillow. The method is easy to operate, inexpensive, and can be used for mass production. The produced pillow is plastic and can be molded with different shapes. The graphene quantum dots have an antibacterial effect, thus preventing the pillows from becoming mildewy.

In the disclosure, the terms such as “first” and “second” are only used for convenience of description, and do not necessarily require or imply any such actual relationship or order therebetween. Moreover, the terms “comprising”, “including” or any other variation thereof are intended to cover non-exclusive inclusion, so that a process, method, article or device that includes a series of elements includes not only those elements, but also other elements that are not explicitly listed, or elements inherent in such process, method, article or device. Unless otherwise noted, the statement “includes an element . . . ” does not exclude the existence of other identical elements in the process, method, article or equipment including the element.

It will be obvious to those skilled in the art that changes and modifications may be made, and therefore, the aim in the appended claims is to cover all such changes and modifications.

What is claimed is:

1. A composite material, comprising, by weight:
50-70 parts of polyol;
15-35 parts of polyether polyol;
0.5-1.5 parts of a polyester pigment or water-based resin-free pigment having a particle size of 100-500 meshes;
2.7-3.4 parts of silicone oil;
0.1-0.3 parts of a crosslinking agent;
0.1-0.3 parts of a catalyst;
2-6 parts of water; and
0.2-0.7 parts of graphene quantum dots (GQDs).

2. The composite material of claim 1, wherein the polyether polyol comprises 20-30 parts of a first polyether polyol and 5-25 parts of a second polyether polyol.

3. The composite material of claim 2, wherein the first polyether polyol is propylene oxide polyether polyol terminated with ethylene oxide accounting for 15 wt. % of the composite material, and has a molecular weight of 1000-2000, a functionality of 3, and a hydroxyl value of 50-170.

4. The composite material of claim 2, wherein the second polyether polyol is ethylene oxide polyol terminated with propylene oxide accounting for 15 wt. % of the composite material, and has a functionality of 2 and a hydroxyl value of 100.

5. The composite material of claim 3, wherein the propylene oxide polyether polyol terminated with ethylene oxide accounting for 15 wt. % of the composite material is prepared as follows: with low molecular weight polyether diol as an initiator, in the presence of the catalyst, mixing propylene oxide and polyether diol, and then adding ethylene oxide, as an end-capping agent and accounting for 15 wt. % of the composite material, to a mixture of propylene oxide and polyether diol; neutralizing, filtering, and concentrating the mixture under vacuum.

6. The composite material of claim 4, wherein the ethylene oxide polyol terminated with propylene oxide accounting for 15 wt. % of the composite material is prepared as follows: with low molecular weight polyether diol as an initiator, in the presence of the catalyst, mixing ethylene oxide and polyether diol, and then adding propylene oxide, as an end-capping agent and accounting for 15 wt. % of the composite material, to a mixture of ethylene oxide and polyether diol; and neutralizing, filtering, and concentrating the mixture under vacuum.

7. The composite material of claim 1, wherein the graphene quantum dots comprise a carbon nano material with a size of a graphene sheet less than 100 nm and a number of graphene sheets less than 10.

8. The composite material of claim 1, wherein the silicone oil comprises dimethyl silicone oil and polyether silicone oil with a mass ratio of 1:4 thereof.

9. A method of preparing the composite material of claim 1, the method comprising:
adding 50-70 parts by weight of polyol, 20-30 parts by weight of a first polyether polyol, and 5-25 parts by weight of a second polyether polyol to a reactor, and stirring at a temperature of 50-70° C.;
adding 2.7-3.4 parts of silicone oil, 0.1-0.3 parts of the crosslinking agent, 0.1-0.3 parts of the catalyst, and 2-6 parts of water to the reactor, and centrifuging a resulting mixture at a speed of 300-500 rpm; and
adding 0.2-0.7 parts of graphene quantum dots and 0.5-1.5 parts of the polyester pigment or water-based resin-free pigment to the reactor, and allowing a mixture in the reactor to react at 10-30° C.

10. A method of preparing a pillow, the method comprising molding the composite material of claim 1 into a pillow.
